(19) United States
(12) Patent Application Publication
(10) Pub. No.: US 2013/0066669 A1
(43) Pub. Date: Mar. 14, 2013

(54) SERVICE EXCEPTION ANALYSIS SYSTEMS AND METHODS

(71) Applicants: Marc Daniel Stevens, Louisville, KY (US); Allan Brady Cole, Louisville, KY (US)

(72) Inventors: Marc Daniel Stevens, Louisville, KY (US); Allan Brady Cole, Louisville, KY (US)

(73) Assignee: UNITED PARCEL SERVICE OF AMERICA, INC., Atlanta, GA (US)

(21) Appl. No.: 13/612,306

(22) Filed: Sep. 12, 2012

Related U.S. Application Data
(60) Provisional application No. 61/533,608, filed on Sep. 12, 2011.

(51) Int. Cl. G06Q 10/00

(52) U.S. Cl. 705/7.14; 705/7.38; 705/7.42

(57) ABSTRACT

Various embodiments provide a service exception analysis system for identifying the existence of one or more service exceptions incurred during actual transport of one or more of a plurality of packages. The system comprises one or more computer processors configured to receive actual data related to one or more observed parameters associated with transport of at least one of the plurality of packages; retrieve at least a portion of forecast data contained in one or more memory storage areas, the forecast data being related to one or more expected parameters associated with transport; compare the actual and forecast data to identify one or more discrepancies; analyze the one or more discrepancies to verify whether one or more service exceptions exist; and in response to one or more service exceptions being identified, generate one or more service exception reports. Associated computer program products and computer-implemented methods are also provided.

### CROSS-REFERENCE TO RELATED APPLICATIONS

This application claims priority to U.S. Application Ser. No. 61/533,608, filed Sep. 12, 2011, which is hereby incorporated herein in its entirety.

### BACKGROUND

Shipping carriers (e.g., common carriers, such as United Parcel Service, Inc. (UPS), FedEx, United States Postal Service (USPS), etc.) daily transport millions of packages over tens of thousands of routes to and from a variety of clients for different purposes. Generally, shipping carriers may reference and use multiple systems to monitor and analyze such activities for purposes including, amongst other things, the identification of service exceptions.

Generally speaking, service exceptions comprise instances wherein actual transportation of packages departs sufficiently from one or more predicted or expected parameters, as may be predetermined by the shipping carriers or otherwise. Because service exceptions represent any one or more of errors, inefficiencies, and/or impacts, all of which reflect negatively upon the quality of service provided by shipping carriers, efficient and effective identification and handling thereof is desirable.

In previous configurations, the multiple systems employed to monitor and analyze parameters associated with transport of a plurality of packages resulted in multiple reports, oftentimes not consolidated, and still further, rarely targeted to parties identified as responsible for creation of the pertinent service exceptions. Thus, a need exists to provide a unified system that automatically consolidates the various predictive and observed data associated with package transit, automatically handles the identification, management, and reporting of service exceptions contained therein, without extensive burden upon personnel and/or infrastructure elements.

### BRIEF SUMMARY

According to various embodiments of the present invention, a service exception analysis system is provided for determining whether one or more service exceptions occur during transport of a plurality of packages. The system comprises one or more computer processors and one or more memory storage areas containing forecast data related to one or more expected parameters associated with transport of a plurality of packages. The one or more computer processors are configured to: (A) receive actual data related to one or more observed parameters associated with transport of at least one of the plurality of packages; (B) retrieve at least a portion of the forecast data contained in the one or more memory storage areas; (C) compare the actual data and the portion of the forecast data to identify one or more discrepancies; (D) analyze the one or more discrepancies to verify whether one or more service exceptions exist; and (E) in response to one or more service exceptions being identified, generate one or more service exception reports.

According to various embodiments of the present invention, a computer program product is provided comprising at least one computer-readable storage medium having computer-readable program code portions embodied therein. The computer-readable program code portions comprise a first executable portion configured for receiving data associated with transport of a plurality of packages. The data comprises: forecast data related to one or more expected parameters associated with transport of a plurality of packages; and actual data related to one or more observed parameters associated with transport of at least one of the plurality of packages. The computer-readable program code portions further comprise: a second executable portion configured for comparing the actual data relative to the forecast data to identify one or more discrepancies; and a third executable portion configured for analyzing the one or more discrepancies to verify whether one or more service exceptions exist.

According to various embodiments of the present invention, a computer-implemented method is provided for managing service exceptions related to transport of a plurality of packages. Various embodiments of the method comprise the steps of: (A) receiving and storing actual data within one or more memory storage areas, the actual data being related to one or more observed parameters associated with the transport of at least one of the plurality of packages; (B) retrieving from the one or more memory storage areas at least a portion of forecast data, the forecast data being related to one or more expected parameters associated with the transport of the at least one of the plurality of packages; (C) comparing, via at least one computer processor, the actual data and the portion of the forecast data to identify one or more discrepancies; (D) analyzing, via the at least one computer processor, the one or more discrepancies to verify whether one or more service exceptions exist; and (E) in response to one or more service exceptions being identified, generating one or more service exception reports.

### BRIEF DESCRIPTION OF THE SEVERAL VIEWS OF THE DRAWING(S)

The accompanying drawings incorporated herein and forming a part of the disclosure illustrate several aspects of the present invention and together with the detailed description serve to explain certain principles of the present invention. In the drawings, which are not necessarily drawn to scale:

FIG. 1 is a block diagram of a service exception analysis system (SEAS) 20 according to various embodiments;

FIG. 2 is schematic block diagram of a SEAS server 200 according to various embodiments;

FIG. 3 illustrates an overall process flow for consolidated service exception management via various modules of the SEAS server 200 according to various embodiments;

FIG. 4 illustrates a schematic diagram of various databases that are utilized by the SEAS 20 shown in FIG. 1 according to various embodiments;

FIG. 5 is a schematic block diagram of a data module 400, a comparison module 500, a verification module 600, and a report module 700, as also illustrated in FIG. 2 according to various embodiments;

FIG. 6 illustrates a process flow for the data module 400 shown in FIG. 2 according to various embodiments;

FIG. 7 illustrates a process flow for the comparison module 500 shown in FIG. 2 according to various embodiments;

FIG. 8 illustrates a process flow for the verification module 600 shown in FIG. 2 according to various embodiments;

FIG. 9 illustrates a process flow for the report module 700 shown in FIG. 2 according to various embodiments;

FIG. 10 is an exemplary summary exception report 1000 of the SEAS 20 according to various embodiments;

FIG. 11 is an exemplary summary exception report 1100 of the SEAS 20 according to various embodiments;

FIG. 12 is an exemplary detailed exception report 1200 of the SEAS 20 according to various embodiments;

FIG. 13 is an exemplary detailed discrepancy report 1300 of the SEAS 20 according to various embodiments;

FIG. 14 is an exemplary tracking number search detailed report 1400 of the SEAS 20 according to various embodiments;

FIG. 15 is another exemplary shipper performance report 1500 of the SEAS 20 according to various embodiments; and

FIG. 16 is an exemplary historical trend chart 1600 of the SEAS 20 according to various embodiments.

### DETAILED DESCRIPTION OF VARIOUS EMBODIMENTS

Various embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein. Rather, these embodiments are provided so that this disclosure will satisfy applicable legal requirements. Unless otherwise defined, all technical and scientific terms used herein have the same meaning as commonly known and understood by one of ordinary skill in the art to which the invention relates. The term “or” is used herein in both the alternative and conjunctive sense, unless otherwise indicated. Like numbers refer to like elements throughout.

Apparatuses, Methods, Systems, and Computer Program Products

As should be appreciated, various embodiments may be implemented in various ways, including as apparatuses, methods, systems, or computer program products. Accordingly, the embodiments may take the form of an entirely hardware embodiment, or an embodiment in which a processor is programmed to perform certain steps. Furthermore, various implementations may take the form of a computer program product on a computer-readable storage medium having computer-readable program instructions embodied in the storage medium. In such embodiments, any suitable computer-readable storage medium may be utilized including hard disks, CD-ROMs, optical storage devices, or magnetic storage devices.

Various embodiments are described below with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

Exemplary System Architecture

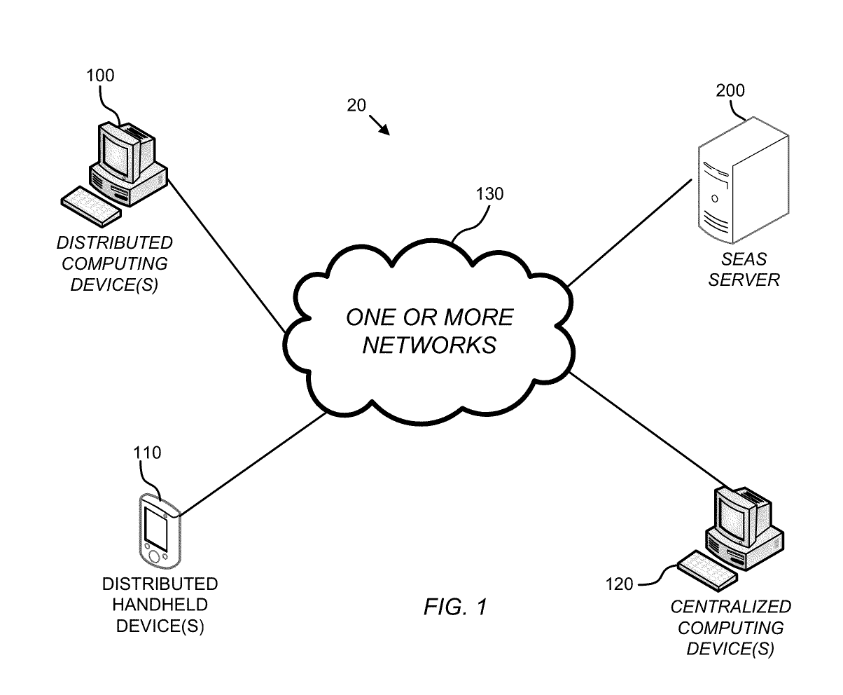

FIG. 1 is a block diagram of a service exception analysis system (SEAS) 20 that can be used in conjunction with various embodiments of the present invention. In at least the illustrated embodiment, the system 20 may include one or more distributed computing devices 100, one or more distributed handheld devices 110, and one or more central computing devices 120, each configured in communication with a SEAS server 200 via one or more networks 130. While FIG. 1 illustrates the various system entities as separate, standalone entities, the various embodiments are not limited to this particular architecture.

According to various embodiments of the present invention, the one or more networks 130 may be capable of supporting communication in accordance with any one or more of a number of second-generation (2G), 2.5G, third-generation (3G), and/or fourth-generation (4G) mobile communication protocols, or the like. More particularly, the one or more networks 130 may be capable of supporting communication in accordance with 2G wireless communication protocols IS-136 (TDMA), GSM, and IS-95 (CDMA). Also, for example, the one or more networks 130 may be capable of supporting communication in accordance with 2.5G wireless communication protocols GPRS, Enhanced Data GSM Environment (EDGE), or the like. In addition, for example, the one or more networks 130 may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones). As yet another example, each of the components of the system 5 may be configured to communicate with one another in accordance with techniques such as, for example, radio frequency (RF), Bluetooth™, infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like.

Although the distributed computing device(s) 100, the distributed handheld device(s) 110, the central computing device(s) 120, and the network planning tool server 200 are illustrated in FIG. 1 as communicating with one another over the same network 130, these devices may likewise communicate over multiple, separate networks. For example, while the central computing devices 120 may communicate with the server 200 over a wireless personal area network (WPAN) using, for example, Bluetooth techniques, one or more of the distributed devices 100, 110 may communicate with the server 200 over a wireless wide area network (WWAN), for example, in accordance with EDGE, or some other 2.5G wireless communication protocol.

According to one embodiment, in addition to receiving data from the server 200, the distributed computing devices 100, the distributed handheld devices 110, and the central computing devices 120 may be further configured to collect and transmit data on their own. Indeed, the distributed computing devices 100, the distributed handheld devices 110, and the central computing devices 120 may be any device associated with a carrier (e.g., a common carrier, such as UPS, FedEx, USPS, etc.). In certain embodiments, at least the distributed computing devices 100 may be associated with a shipper, as opposed to a carrier. Regardless, in various embodiments, the distributed computing devices 100, the distributed handheld devices 110, and the central computing devices 120 may be capable of receiving data via one or more input units or devices, such as a keypad, touchpad, barcode scanner, radio frequency identification (RFID) reader, interface card (e.g., modem, etc.) or receiver. The distributed computing devices 100, the distributed handheld devices 110, and the central computing devices 120 may further be capable of storing data to one or more volatile or non-volatile memory modules, and outputting the data via one or more output units or devices, for example, by displaying data to the user operating the device, or by transmitting data, for example over the one or more networks 130. One type of a distributed handheld device 110, which may be used in conjunction with embodiments of the present invention is the Delivery Information Acquisition Device (DIAD) presently utilized by UPS.

Service Exception Analysis System (SEAS) Server 200

In various embodiments, the network Service Exception Analysis System (SEAS) server 200 includes various systems for performing one or more functions in accordance with various embodiments of the present invention, including those more particularly shown and described herein. It should be understood, however, that the server 200 might include a variety of alternative devices for performing one or more like functions, without departing from the spirit and scope of the present invention. For example, at least a portion of the server 200, in certain embodiments, may be located on the distributed computing device(s) 100, the distributed handheld device(s) 110, and the central computing device(s) 120, as may be desirable for particular applications.

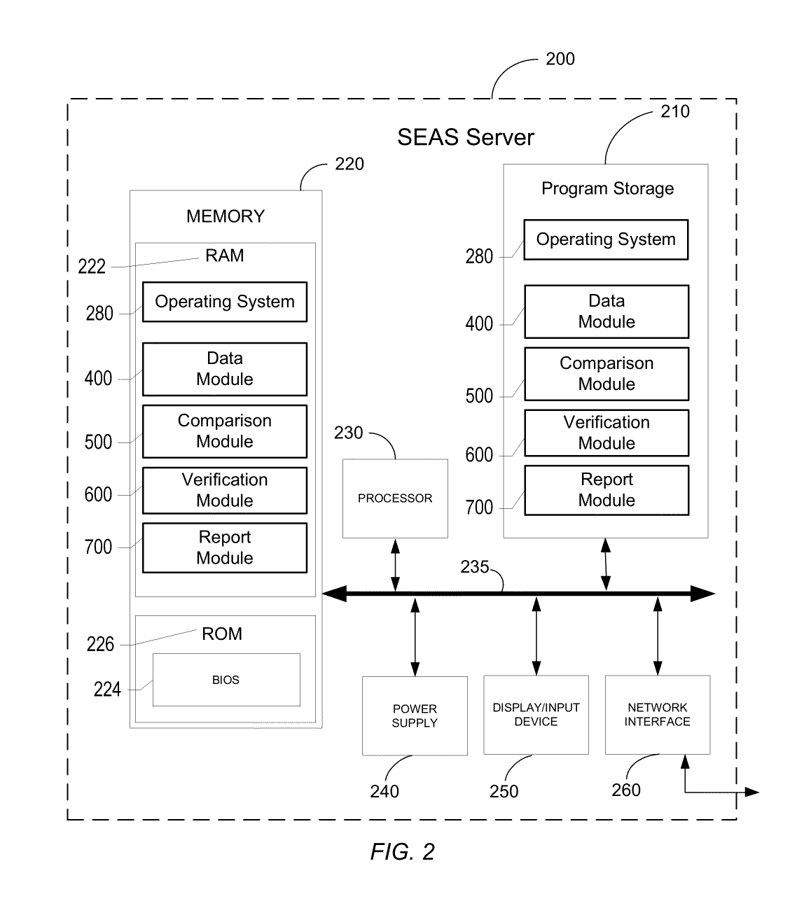

FIG. 2 is a schematic diagram of the SEAS server 200 according to various embodiments. The server 200 includes a processor 230 that communicates with other elements within the server via a system interface or bus 235. Also included in the server 200 is a display/input device 250 for receiving and displaying data. This display/input device 250 may be, for example, a keyboard or pointing device that is used in combination with a monitor. The server 200 further includes memory 220, which preferably includes both read only memory (ROM) 226 and random access memory (RAM) 222. The server's ROM 226 is used to store a basic input/output system 224 (BIOS), containing the basic routines that help to transfer information between elements within the network planning tool server 200.

In addition, the SEAS server 200 includes at least one storage device or program storage 210, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 210 are connected to the system bus 235 by an appropriate interface. The storage devices 210 and their associated computer-readable media provide nonvolatile storage for a personal computer. As will be appreciated by one of ordinary skill in the art, the computer-readable media described above could be replaced by any other type of computer-readable media known in the art. Such media include, for example, magnetic cassettes, flash memory cards, digital video disks, and Bernoulli cartridges.

Although not shown, according to an embodiment, the storage device 210 and/or memory of the SEAS server 200 may further provide the functions of a data storage device, which may store historical and/or current delivery data and delivery conditions that may be accessed by the server 200. In this regard, the storage device 210 may comprise one or more databases. The term “database” refers to a structured collection of records or data that is stored in a computer system, such as via a relational database, hierarchical database, or network database and as such, should not be construed in a limiting fashion.

A number of program modules comprising, for example, one or more computer-readable program code portions executable by the processor 230, may be stored by the various storage devices 210 and within RAM 222. Such program modules include an operating system 280, a data module 400, a comparison module 500, a verification module 600, and a report module 700. In these and other embodiments, the various modules 400, 500, 600, 700 control certain aspects of the operation of the SEAS server 200 with the assistance of the processor 230 and operating system 280.

In general, as will be described in further detail below, the data module 400 is configured to (i) receive, store, manage, and provide a variety of forecast data associated with one or more expected parameters for a transport of a plurality of packages; and (ii) receive, store, manage, and provide a variety of actual data associated with one or more observed parameters for the transport of the plurality of packages. The comparison module 500 is configured to activate a comparison tool, which compares the received actual data to at least a portion of the forecast data. In certain embodiments, it is the expected parameters that are compared against the actual parameters, as observed. In so doing, the comparison module 500 is configured to identify clean data and discrepancy data. The verification module 600 is then configured to activate a verification tool, which analyzes the discrepancy data to ascertain whether the identified one or more discrepancies constitute service exceptions. Once one or more service exceptions are identified, the report module 800 is notified and is, in turn, configured to generate and/or distribute one or more exception reports.

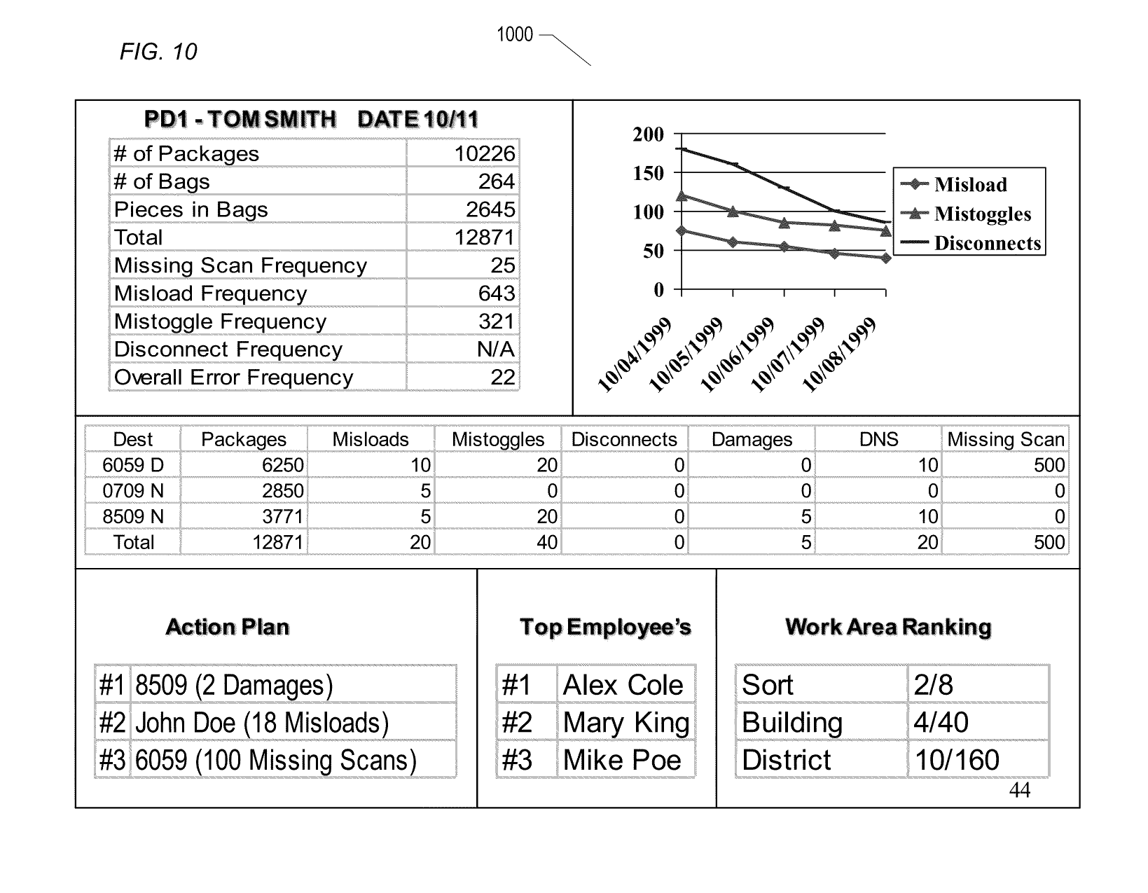

In various embodiments, the program modules 400, 500, 600, 700 are executed by the SEAS server 200 and are configured to generate one or more graphical user interfaces, reports, and/or charts, all accessible to various users of the system 20. Exemplary interfaces, reports, and charts are described in more detail below in relation to FIGS. 10-16. In certain embodiments, the user interfaces, reports, and/or charts may be accessible via one or more networks 130, which may include the Internet or other feasible communications network, as previously discussed. In other embodiments, one or more of the modules 400, 500, 600, 700 may be stored locally on one or more of the distributed computing devices 100, the distributed handheld devices 110, and/or the central computing devices 120, and may be executed by one or more processors of the same. According to various embodiments, the modules 400, 500, 600, 700 may send data to, receive data from, and utilize data contained in, a database, which may be comprised of one or more separate, linked and/or networked databases.

Also located within the SEAS server 200 is a network interface 260 for interfacing and communicating with other elements of the one or more networks 130. It will be appreciated by one of ordinary skill in the art that one or more of the server 200 components may be located geographically remotely from other server components. Furthermore, one or more of the server 200 components may be combined, and/or additional components performing functions described herein may also be included in the server.

While the foregoing describes a single processor 230, as one of ordinary skill in the art will recognize, the SEAS server 200 may comprise multiple processors operating in conjunction with one another to perform the functionality described herein. In addition to the memory 220, the processor 230 can also be connected to at least one interface or other means for displaying, transmitting and/or receiving data, content or the like. In this regard, the interface(s) can include at least one communication interface or other means for transmitting and/or receiving data, content or the like, as well as at least one user interface that can include a display and/or a user input interface. The user input interface, in turn, can comprise any of a number of devices allowing the entity to receive data from a user, such as a keypad, a touch display, a joystick or other input device.

While reference is made to the SEAS “server” 200, as one of ordinary skill in the art will recognize, embodiments of the present invention are not limited to traditionally defined server architectures. Still further, the system of embodiments of the present invention is not limited to a single server, or similar network entity or mainframe computer system. Other similar architectures including one or more network entities operating in conjunction with one another to provide the functionality described herein may likewise be used without departing from the spirit and scope of embodiments of the present invention. For example, a mesh network of two or more personal computers (PCs), similar electronic devices, or handheld portable devices, collaborating with one another to provide the functionality described herein in association with the SEAS server 200 may likewise be used without departing from the spirit and scope of embodiments of the present invention.

According to various embodiments, many individual steps of a process may or may not be carried out utilizing the computer systems and/or servers described herein, and the degree of computer implementation may vary.

SEAS Server 200 Logic Flow

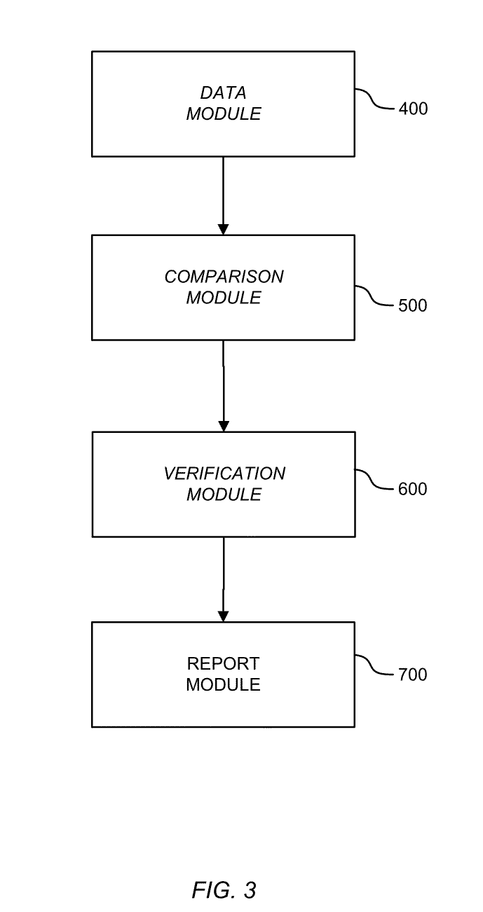

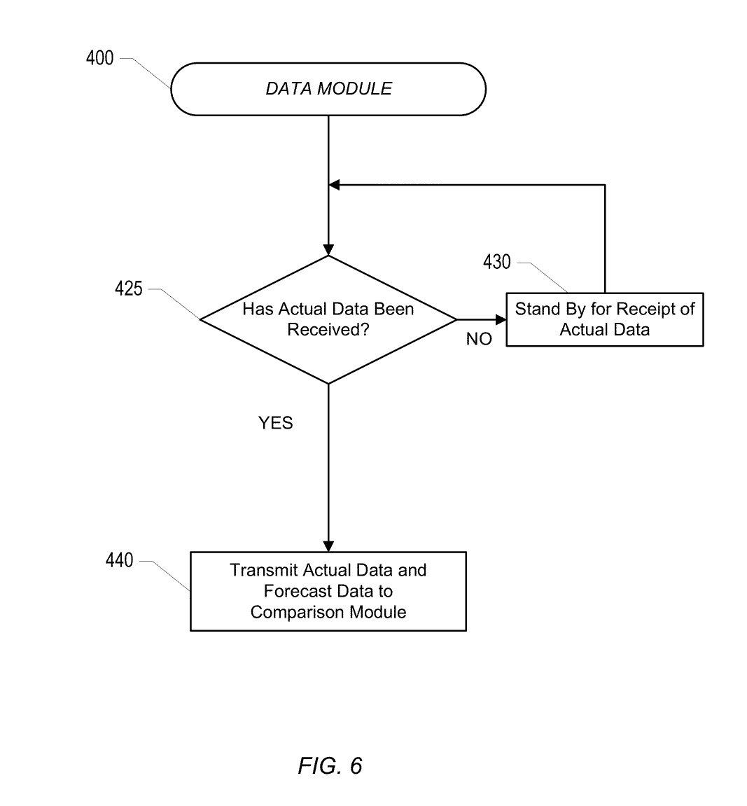

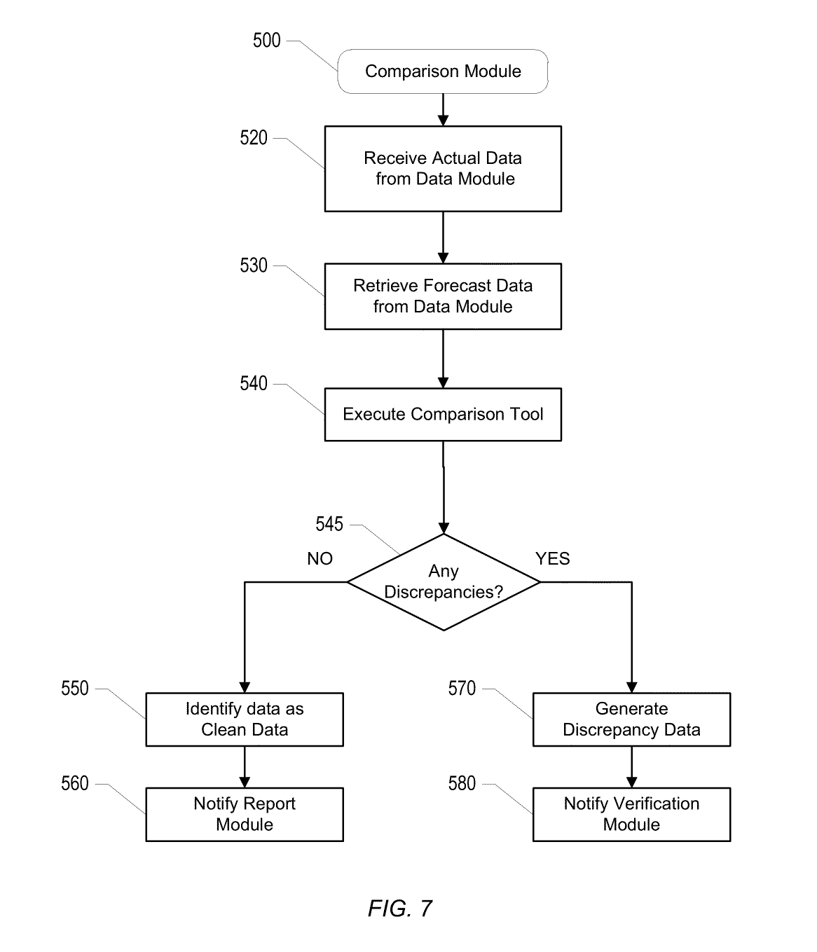

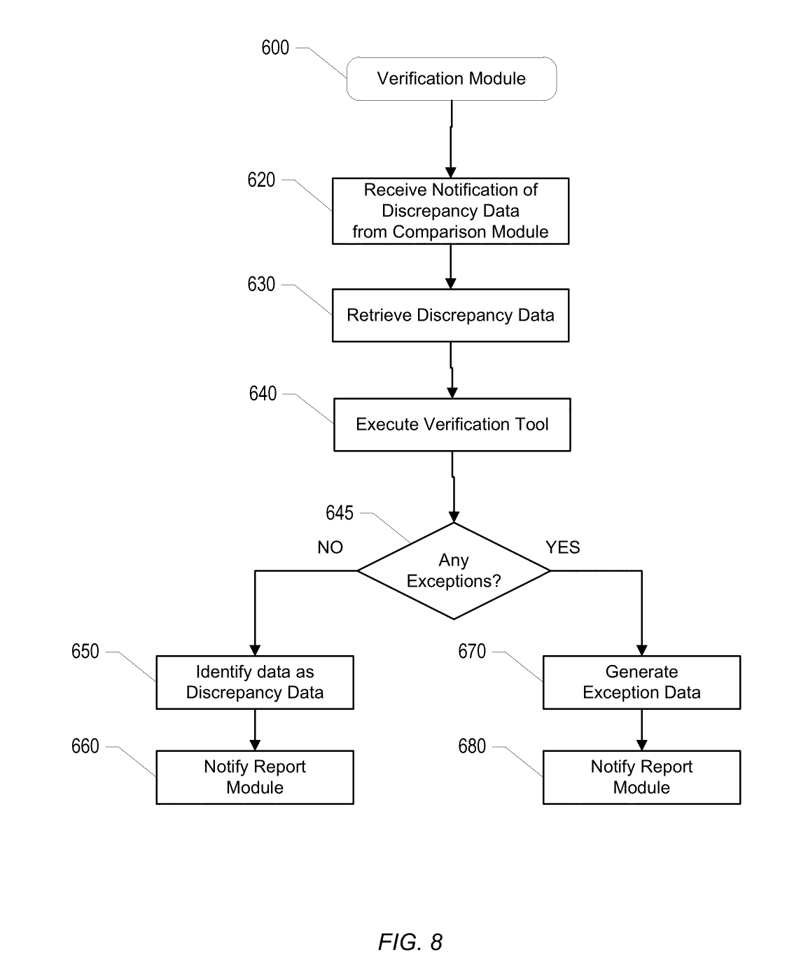

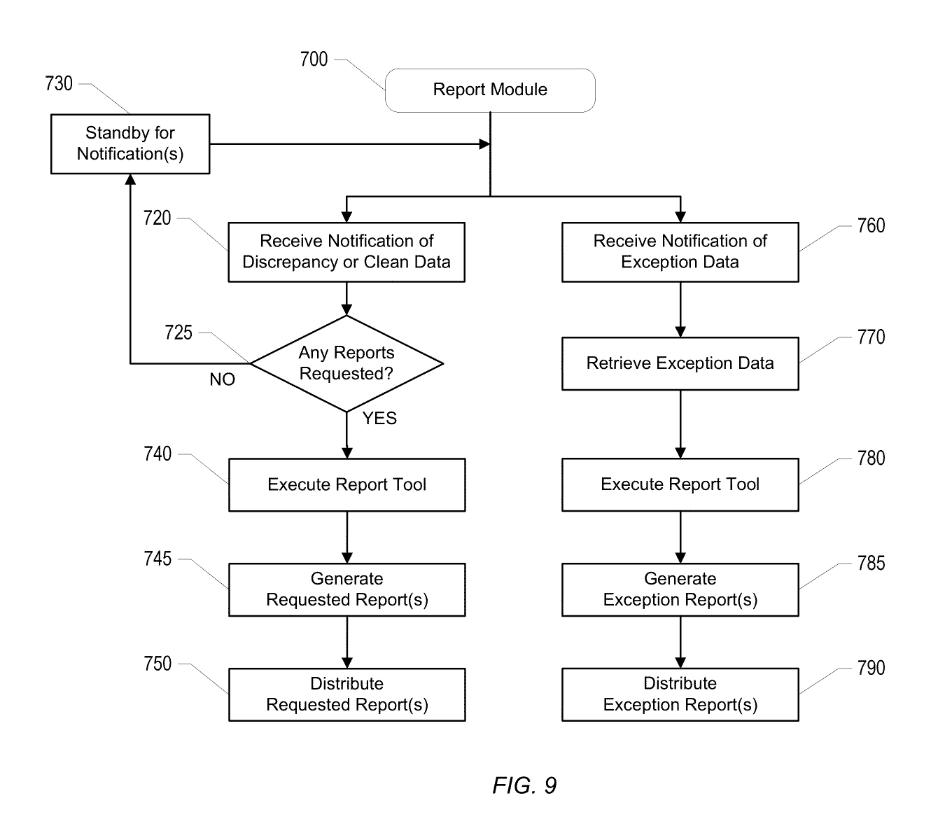

Reference is now made to FIGS. 3 and 5-9, which illustrate various logical process flows executed by various embodiments of the modules described above. In particular, FIG. 3 illustrates the overall relationship of the modules 400, 500, 600, 700 of the service exception analysis system (SEAS) server 200, according to various embodiments. As illustrated, operation of the SEAS 20 begins, according to various embodiments, with the execution of the data module 400, which maintains various forecast data that has been modeled based upon expected parameters for transport of a plurality of packages and provides at least a portion of such, along with received actual data to the comparison module 500, upon receipt thereof. Steps performed by various embodiments of the data module 400 are described in relation to FIG. 6; steps performed by various embodiments of the comparison module 500 are described in relation to FIG. 7; steps performed by various embodiments of the verification module 600 are described in relation to FIG. 8; and steps performed by various embodiments of the report module 800 are described in relation to FIG. 9.

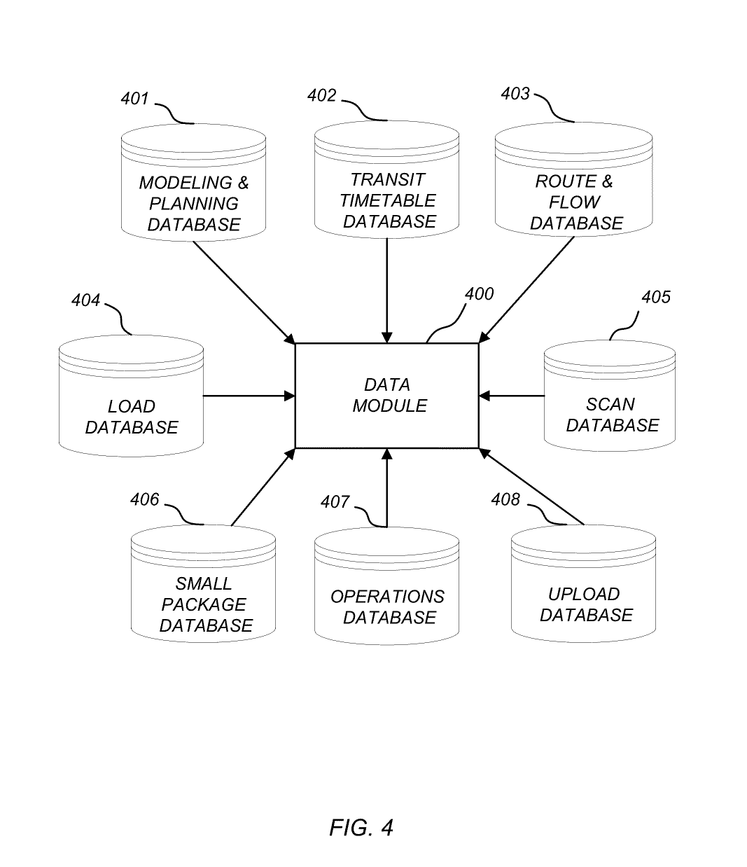

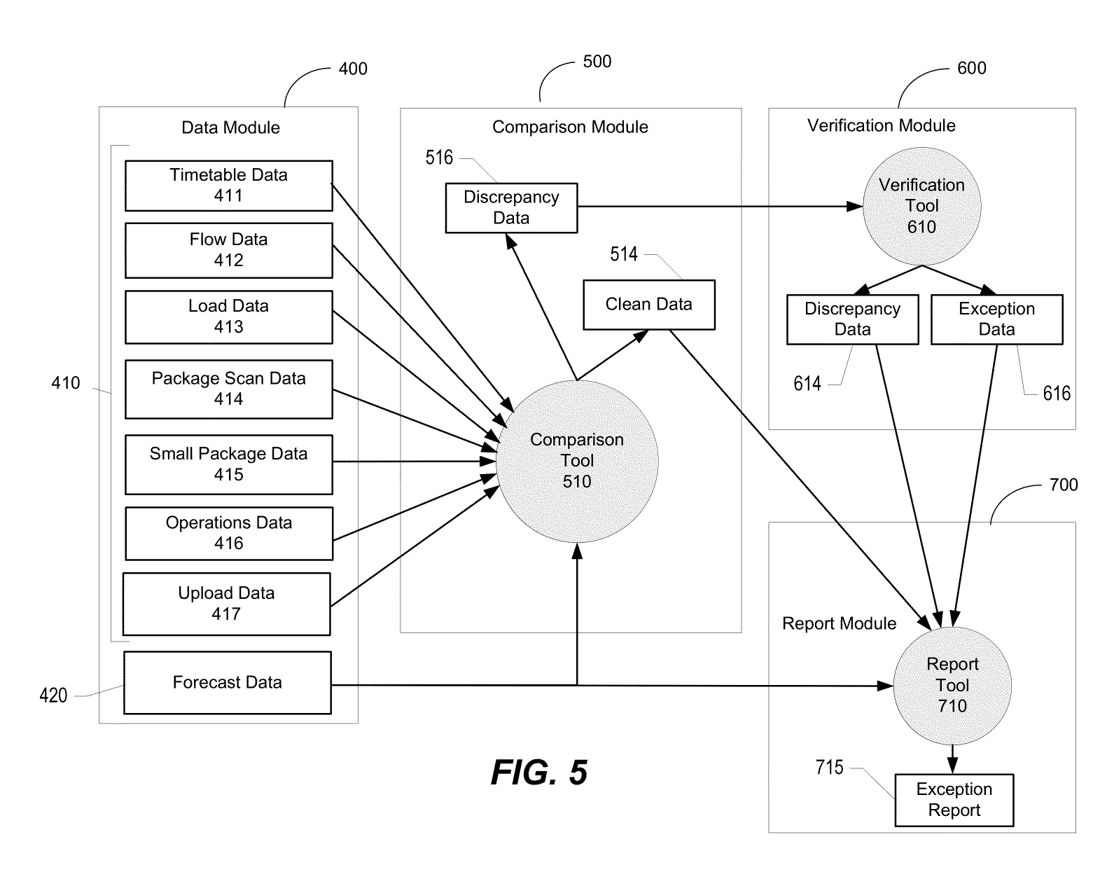

As described in more detail below in relation to FIGS. 4 and 5, the data module 400, according to various embodiments, retrieves newly received actual (e.g., observed during transit/transport) data 410 and existing forecast (e.g., modeled or simulated transit flow) data 420 from one or more databases in communication with the module 400. FIG. 4 illustrates a block diagram of various exemplary databases from which the data module 400 receives, retrieves, and/or stores this information. In particular, in at least the embodiment shown in FIG. 4, the following databases are provided: a modeling and planning database 401, a transit timetable database 402, a route and flow database 403, a load database 404, a scan database 405, a small package database 406, an operations database 407, and an upload database 408. Although the embodiment of FIG. 4 shows these databases 401, 402, 403, 404, 405, 406, 407, 408 as being separate databases each associated with different types of data, but in various other embodiments, some or all of the data may be stored in the same database.

It should be appreciated that the various illustrated databases may encompass data previously maintained by one or more separate service reporting systems, so as to facilitate consolidation and integration of the same within the single SEAS 20 described herein. As a non-limiting example, the one or more databases described herein may consolidate and integrate data previously accessible via multiple and oftentimes duplicative service reporting systems, such as N121 for late package to destination reports, TTR/TNT for late package to delivery reports, IMR for missing scan reports, SQR for service quality reports, SIMS for small information management reports, volume management systems, misflow management systems, and simulation flow management systems. Under historical configurations, if a user wished to, for example, receive reports related to particular service exceptions, impacts, discrepancies or the like for any of a variety of parameters such as transit timetable, misflow, misload, misscan, small packages, operational errors, and/or errant uploads, the user would need to individually and separately access a plurality of service reporting systems (as identified above) and request particularly desirable reports.

The unified SEAS architecture 20 described herein eliminates undue burdens, inefficiencies, and the like created by such historical configurations by providing a single interface, which users may customize at a single instance for automated receipt of one or more reports, upon occurrence of one or more service exceptions, discrepancies, or the like. The unified SEAS architecture 20 described herein further automatically determines, weighs, and assigns responsibility for creation of the service exception, facilitating not only automatic report generation, but automatic transmittal to only those users assigned responsibility. Beyond the efficiency and effectively provided by automatic report generation, the responsibility assignment and focused distribution features provide still further benefits, for example, by reducing drastically the scope and content of reports though which users must sift. These and still other advantages and benefits, as will be described in further detail below, are realized, at least in part, by consolidation of at least the various non-limiting exemplary databases into the unified SEAS architecture 20.

According to various embodiments, the modeling and planning database 401 may be configured to store and maintain at least the forecast data 420. Such forecast data 420 may comprise a variety of data regarding one or more expected parameters associated with the transit (e.g., intake, transport, and delivery) of a plurality of packages. Such forecast data 420 may further, in certain embodiments, comprise modeling and simulation data, as generally produced by network planning tools, as commonly known and understood in the art, so as to predictively manage movements of the plurality of packages. Such forecast data 420 in these and still other embodiments, may comprise data related to parameters such as the non-limiting examples of estimated departure times, estimated intermediate arrival/departure times, estimated transit durations, estimated delivery times, estimated load assignments, estimated flow routes, estimated scan locations, times, and frequencies, estimated handling parameters for small packages (e.g., those consolidated within larger packages and/or containers for consolidated handling), estimated operational parameters such as facility volume, load volume, delays, invalid shipping data, re-routes, missing packages or labels upon packages, discrepancy, lookup failures, and the like. As particular non-limiting example, the forecast data may indicate a typical estimated transit time of two days for ground delivery between Los Angeles and New York; however, in any of these and still other embodiments, a variety of alternatives could exist, as commonly known and understood in the art.

According to various embodiments, the transit timetable database 402 may be configured to store and maintain actually recorded (e.g., observed) data related to transit-related milestones for each of a plurality of packages. In this manner, it should be understood that the transit timetable database 402 (and the remaining databases described herein) differ from the modeling and planning database 401 in that they contain actual (e.g., observed data), as compared to estimated or otherwise predictively modeled and/or simulated data. With this in mind, it should be understood that the transit timetable database 402 may comprise actual data received from any one of the distributed handheld device(s) 110, the distributed computing device(s) 100, and the centralized computing device(s) 120, as may be convenient for particular applications. As a non-limiting example, the transit timetable database 402 may receive departure time data related to a particular package from a distributed handheld device 110 such as the DIAD presently utilized by UPS. Upon receipt, the transit timetable database 402 will store such actual/observed/recorded data for later provision to the data module 400, as will be described in further detail below. Of course, in any of these and still other embodiments, a variety of alternatives could exist, as commonly known and understood in the art.

According to various embodiments, the route and flow database 403 may be configured to store and maintain data related to the actual route or path (e.g., flow) observed for each of a plurality of packages during their respective transit movements. In this manner, it should be understood that the route and flow database 403 may comprise actual data received from any one of the distributed handheld device(s) 110, the distributed computing device(s) 100, and the centralized computing device(s) 120, as may be convenient for particular applications. As a non-limiting example, the route and flow database 403 may receive departure location (e.g., route) data related to a particular package from a distributed handheld device 110 such as the DIAD presently utilized by UPS. Upon receipt, the route and flow database 403 will store such actual/observed/recorded data for later provision to the data module 400, as will be described in further detail below. Of course, in any of these and still other embodiments, a variety of alternatives could exist, as commonly known and understood in the art.

According to various embodiments, the route and flow database 403 may be configured to store and maintain data related to the actual route or path (e.g., flow) observed for each of a plurality of packages during their respective transit movements. In this manner, it should be understood that the route and flow database 403 may comprise actual data received from any one of the distributed handheld device(s) 110, the distributed computing device(s) 100, and the centralized computing device(s) 120, as may be convenient for particular applications. As a non-limiting example, the route and flow database 403 may receive departure location (e.g., route) data related to a particular package from a distributed handheld device 110 such as the DIAD presently utilized by UPS. Upon receipt, the route and flow database 403 will store such actual/observed/recorded data for later provision to the data module 400, as will be described in further detail below. Of course, in any of these and still other embodiments, a variety of alternatives could exist, as commonly known and understood in the art.

According to various embodiments, the load database 404 may be configured to store and maintain data related to vehicle (e.g., truck, airplane, etc.) load and unload activities, as recorded and/or observed for each of a plurality of packages during their respective transit movements. In this manner, it should be understood that the load database 404 may comprise actual data received from any one of the distributed handheld device(s) 110, the distributed computing device(s) 100, and the centralized computing device(s) 120, as may be convenient for particular applications. As a non-limiting example, the load database 404 may receive a vehicle load indicator (e.g., via scan or otherwise), as related to a particular package, whereby the indicator may be acquired and/or received from a distributed handheld device 110 such as the DIAD presently utilized by UPS. Upon receipt, the load database 404 will store such actual/observed/recorded data for later provision to the data module 400, as will be described in further detail below. Of course, in any of these and still other embodiments, a variety of alternatives could exist, as commonly known and understood in the art.

According to various embodiments, the scan database 405 may be configured to store and maintain data related to the actual package scan events, as observed for each of a plurality of packages during their respective transit movements. In this manner, it should be understood that the scan database 405 may comprise actual data received from any one of the distributed handheld device(s) 110, the distributed computing device(s) 100, and the centralized computing device(s) 120, as may be convenient for particular applications. As a non-limiting example, the scan database 405 may receive an indication that a particular package was scanned upon arrival at an intermediate destination location, as performed and/or transmitted by a distributed handheld device 110 such as the DIAD presently utilized by UPS. Upon receipt, the scan database 405 will store such actual/observed/recorded data for later provision to the data module 400, as will be described in further detail below. Of course, in any of these and still other embodiments, a variety of alternatives could exist, as commonly known and understood in the art.

According to various embodiments, the small package database 406 may be configured to store and maintain a variety of data related to the transport of small packages, as may, in certain instances occur within the framework of larger over-package containers, as is commonly known and understood in the art. In this manner, it should be understood that the small package database 406 may comprise actual data that may overlap in nature and scope with any of the various databases described elsewhere herein, but particularly limited and tailored to such data with regard to small package parcels. As a non-limiting example, the small package database 406 may receive an indication that a particular small package was scanned upon arrival at an intermediate destination location, as performed and/or transmitted by a distributed handheld device 110 such as the DIAD presently utilized by UPS. Upon receipt, the small package database 406 will store such actual/observed/recorded data for later provision to the data module 400, as will be described in further detail below. In certain embodiments, small package related data may be duplicated in various remaining pertinent databases (e.g., the scan database 405), while in other embodiments, small package actual/observed data may be maintained wholly separately. Of course, in any of these and still other embodiments, a variety of alternatives could exist, as commonly known and understood in the art.

According to various embodiments, the operations database 407 may be configured to store and maintain data related to the observed operational parameters. In this manner, it should be understood that the operations database 407 may comprise actual data received from any one of the distributed handheld device(s) 110, the distributed computing device(s) 100, and the centralized computing device(s) 120, as may be convenient for particular applications. As non-limiting examples, the operational parameters may include package volume, facility volume, facility activation, package damages, invalid package labeling, re-routing data, minor shipping discrepancies, lookup failures, and the like. In other words according to certain embodiments, the operational parameters may include any of a variety of parameters related to ensuring efficiency and effectiveness of operational assets not otherwise captured in any of the various databases previously described herein. Upon receipt, the operations database 407 will store such actual/observed/recorded data for later provision to the data module 400, as will be described in further detail below. Of course, in any of these and still other embodiments, a variety of alternatives could exist, as commonly known and understood in the art.

According to various embodiments, any of the previously described databases may be configured to store and maintain not only textually based data, but also graphically based data, as may be generated by the SEAS 20 (or otherwise) and based, at least in part, upon the textually based data. Still further graphical (e.g., charts, graphs, maps, etc.) may also be stored within one or more of the databases, wherein such may be, at least in part, independently derived, relative to the textually based data. Non-limiting examples of such graphically based data include trend graphs, historical plot charts, pie charts, diagrams, and the like, all as will be described in further detail elsewhere herein with reference to at least FIGS. 10-11 and 14-16. In any event, it should be understood that in any of these and still other embodiments, the graphically based data may be used to visually combine various portions of data contained within the various databases previously described herein.

Exemplary System Operation

As indicated above, various embodiments of the SEAS server 200 execute various modules (e.g., modules 400, 500, 600, 700) to simulate and model distribution flows of a consignor's packages from each of one or more hubs within the carrier's shipping network and facilitate generation of an optimal network plan for the handling thereof, taking into account a plurality of factors and considerations (e.g., data and information), as retrieved from the above-described various databases and/or as provided by one or more users of the network planning tool 201 and/or the system architecture 20 associated therewith.

According to the embodiment shown in FIG. 5, the SEAS server 200 begins with the execution of the data module 400, which retrieves, stores, and manages a myriad of both actual (e.g., observed) data 410 and forecast (e.g., predicted) data 420, both associated with the transit activities for a plurality of packages. When updates are received, particularly in the form of the actual data 410, which is collected during the physical transport of each of the plurality of packages, the data module 400 is generally configured to provide the same, along with at least a portion of the forecast data 420 to the comparison module 500. In certain embodiments, the data module is further configured to provide at least a portion of the forecast data 420 additionally to the report module 700, namely for purposes of the latter generating one or more reports, which may incorporate at least the received portion of the forecast data, as may be desirable for particular applications.

As generally understood in the art, actual data 410 comprises data observed during transit, whether scanned from a particular package or otherwise, while forecast data 420 comprises data modeled and/or simulated in advance of actual transit, so as to predictively establish one or more parameters indicative of efficient and/or effective (e.g., desirable) transportation movement of the plurality of packages. Notably, both types of data are generally known and understood in the art; however, historical configurations have distributed such across a multitude of oftentimes duplicative systems, each generating a plurality of reports based upon monitoring of the transportation movement. That being said, none of such historical configurations, as has been described previously herein, provide a consolidated, automatic system that not only provides a unified monitoring and reporting tool, but also a tool that automatically assigns responsibility for identified service exceptions based upon the actual data 410 and the forecast data 420, thereby significantly simplifying and focusing the error analysis, reporting, and tracking procedures.

In various embodiments, the comparison module 500 is configured to activate a comparison tool 510 that calculates whether one or more discrepancies exist between the received and/or retrieved forecast data 420 and actual data 410. As will be described in further detail below, it should be understood that in certain embodiments, the discrepancies may comprise any of a variety of differences between the observed and actual parameters. In these and still other embodiments, if one or more discrepancies are identified, the comparison module 500 is configured to identify and label at least a portion of the actual data 410 as discrepancy data 516. Discrepancy data 516 is then transmitted, by the comparison module 500, to the verification module 600.

On the other hand, if no discrepancies are identified, the comparison module 500 is configured to identify and label at least a portion of the actual data 410 as clean data 514. Clean data 514, in contrast with discrepancy data 516, is transmitted to the report module 700, all as will be described in further detail below. It should be understood, of course, that in certain embodiments, the clean and/or discrepancy data 514, 516 may only be transmitted to the verification and/or report modules upon request, in which case the comparison module 500 may be simply configured to transmit a notification of the existence of such data to these modules without transmittal (automatic or otherwise) of the data itself at that time. Various alternatives exist, all of which will be described in further detail below.

In various embodiments, the verification module 600 is configured to receive and/or retrieve discrepancy data 516 from the comparison module 500. As will be described in further detail below, the discrepancy data 516 may comprise both actual data 410 and a portion of forecast data 420, namely in at least one embodiment, data related to one or more substantially parallel parameters, whereby the discrepancy is identified. In certain embodiments, the verification module 600, upon receipt and/or retrieval of the discrepancy data 516 is configured to activate a verification tool 610, whereby the module determines whether the discrepancy constitutes one or more service exceptions or not. If one or more service exceptions exist, the verification module 600 identifies and labels exception data 616, which is, in turn, transmitted (either automatically or upon request) to the report module 700. If no service exceptions exist, the verification module 600 identifies and labels discrepancy data 614, which is in essence substantially identical to the discrepancy data 516 (but for being verified). The discrepancy data 614 is likewise, in turn, transmitted (either automatically or upon request) to the report module 700.

According to various embodiments, the report module 700 is configured to receive and/or retrieve various data from each of the data module 400, the comparison module 500, and the verification module 600. In certain embodiments, at least a portion of forecast data 420 may be received and/or retrieved directly from the data module 400, as may be desirable for particular applications. In these and still other embodiments, clean data 514 may be received and/or retrieved from the comparison module 500, while discrepancy data 614 and exception data 616 may be received and/or retrieved from the verification module 600. It should be understood, of course, that the clean, discrepancy, and/or exception data may inherently incorporate at least a portion of forecast data 420 together with actual data 410, in which instances acquisition of forecast data 420 from the data module may be duplicative.

In any of these and still other embodiments, the report module 700 is further configured to activate a report tool 710 upon receipt of one or more types of data. In various embodiments, the report tool 710 is configured, as illustrated in FIG. 5, to generate at least an exception report 715. Of course, any of a variety of reports, containing exception, discrepancy, and/or clean data may be likewise generated by the report tool 710, as will be described in further detail below with reference to at least FIGS. 9-16.

Data Module 400

According to various embodiments, the data module 400 is configured to receive, store, and maintain actual data 410 and forecast data 420, all associated with the transportation movement of a plurality of packages. As generally understood in the art, actual data 410 comprises data observed during transit, whether scanned from a particular package or otherwise, while forecast data 420 comprises data modeled and/or simulated in advance of actual transit, so as to predictively establish one or more parameters indicative of efficient and/or effective (e.g., desirable) transportation movement of the plurality of packages. Notably, both types of data are generally known and understood in the art; however, historical configurations have distributed such across a multitude of oftentimes duplicative systems, each generating a plurality of reports based upon monitoring of the transportation movement. That being said, none of such historical configurations, as has been described previously herein, provide a consolidated, automatic system that not only provides a unified monitoring and reporting tool, but also a tool that automatically assigns responsibility for identified service exceptions based upon the actual data 410 and the forecast data 420, thereby significantly simplifying and focusing the error analysis, reporting, and tracking procedures.

FIG. 6 illustrates steps that may be executed by the data module 400 according to various embodiments. Beginning with step 425, the data module 400 assesses whether any actual data 410, as has been previously described herein, has been received by the module. In certain embodiments, the data module 400 makes this assessment by periodically scanning one or more databases associated with the module (e.g., see FIG. 4) and by identifying some portion of data within one or more of the databases that was not present during a previous periodic scan under step 425. In other embodiments, the one or more databases may be configured to notify the data module 400 of input of some portion of new data, as may be desirable for certain application. In in any of these and still other embodiments, if new actual data 410 is identified, the data module 400 proceeds to step 440; otherwise the module proceeds into a static loop via step 430, thereby awaiting receipt (or notification of) actual data 410.

In various embodiments, the actual data 410 comprises a variety of shipping and transportation related data for a plurality of packages located within one or more databases (see FIG. 4) and as previously described herein. As illustrated in at least FIG. 5, however, the actual data 410 may comprise the non-limiting examples of timetable data 411, flow data 412, load data 413, package scan data 414, small package data 415, operations data 416, and upload data 417. In various embodiments, each of the pieces of the actual data 410 are collected by shipping carriers (e.g., common carriers, such as United Parcel Service, Inc. (UPS), FedEx, United States Postal Service (USPS), etc.) during the actual transport of each of the plurality of packages, so as to monitor, analyze, and report upon various aspects of multiple package shipping and transportation processes. Notably, the data module 400 provides a mechanism by which all of the actual data 410, contrary to historical configurations, is consolidated and available for integration via any of the comparison, verification, and/or report modules 500, 600, 700, as will be described in greater detail below.

In various embodiments, the data module 400 is further configured to receive various pieces of forecast data 420. In certain embodiments, the forecast data 420 may comprise data associated with any of a variety of parameters, as may be modeled and simulated prior to actual transportation of each of the plurality of packages. As a non-limiting example, the forecast data 420 may comprise data indicating times of departure and arrival at a plurality of facilities for a particular package, along with appropriate scans thereof of, for example, a handheld device such as the UPS DIAD. For purposes of clarity and reference, this non-limiting example will be carried throughout herein; of course, it should be understood that still other variations and types of forecast data 420 may be received, stored, and/or analyzed by any of the modules described herein, as may be commonly known and understood in the context of system and flow modeling and simulation applications.

As previously mentioned, if the data module 400 determines that actual data 410 has been received 425 in one or more associated databases (see FIG. 4), the data module is configured, as illustrated in FIG. 6, to proceed to step 440. During step 440, the data module transmits actual data 410 and at least a portion of the forecast data 420 to the comparison module 500. In certain embodiments, the data module 400 may simply provide a notification to the comparison module 500 of receipt of actual data 410, in which instance the comparison module may request such data, along with forecast data 420 deemed pertinent thereto, as determined by the comparison module. Of course, in still other embodiments, the data module 400 may be configured to parse the forecast data 420 so as to transmit only a pre-determined portion thereof, along with the associated actual data 410 to the comparison module 500, as may be desirable for particular applications.

Comparison Module 500

With reference now to FIG. 7, according to various embodiments, the comparison module 500 is configured to receive and/or retrieve actual data 410 and at least a portion of forecast data 420 from the data module 400, as illustrated in steps 520 and 530, respectively. As has been previously described herein, while in certain embodiments it may be the comparison module 500 that actively retrieves the actual and/or forecast data from the data module 400, in other embodiments, any combination of the data may be instead automatically transmitted to the comparison module by the data module. Of course, any of a variety of data transfer mechanisms and parameters may be incorporated between the respective modules, as may be desirable for particular applications.

Remaining with FIG. 7, it should be understood that according to various embodiments, upon receipt and/or retrieval of data in steps 520 and 530, the comparison module 500 is configured to execute (e.g., activate and run) a comparison tool 510, as previously described herein. In various embodiments, the comparison tool 510 is configured to analyze the received data 410, 420 to determine whether one or more discrepancies exist, based upon one or more pre-established package transport parameters. It should be understood that the comparison tool 510 may incorporate any of a variety of algorithms to achieve the data comparison for which it is configured, all as commonly known and understood in the art. In any of these and still other embodiments, however, once the comparison tool 510 is activated, the comparison module 500 is configured to proceed to step 545, wherein it is determined whether or not any discrepancies exist.

For purposes of describing step 545, it is helpful to return to the previous non-limiting example, whereby the comparison tool 510 is configured to compare actual data 410 indicative of a departure scan from a particular facility, as received, with forecast data 420 pertinent to the same parameter. Where, for example, the observed departure scan occurred at 4:15 PM, while the forecast departure scan was predicted for 4:00 PM, the comparison module 500 is configured in step 570 to identify and label (e.g., generate) such as discrepancy data 516. Where, for example, the observed and forecast departure scans were both at 4:00 PM, the comparison module 500 is configured in step 550 to identify and label (e.g., generate) such as clean data.

As may be further understood from FIG. 7, upon identification of clean data 514 (see FIG. 5) in step 550, the comparison module may be according to various embodiments further configured to notify the report module 700 of the identification of the clean data. In certain embodiments, the notification of step 560 may further comprise transmittal of at least some portion of the clean data 514, which may include portions of both actual data 410 and forecast data 420, as analyzed and compared by the comparison tool 510 in step 545. Of course, in other embodiments, the comparison module 500 may be configured to merely notify the report module of the clean data 514, whereby the report module may retrieve the same, as desirable. In still other embodiments, the comparison module 500 may be configured in step 560 to alternatively and/or additionally transmit the clean data 514 to the data module 400, for purposes of, for example, storing and recording the same.

Similarly, upon identification and generation of discrepancy data 516 (see FIG. 5) in step 580, the comparison module 500 may be according to various embodiments further configured to notify the verification module 600 of the existence of the same. In certain embodiments, the notification of step 580 may further comprise transmittal of at least some portion of the discrepancy data 516, which may include portions of both actual data 410 and forecast data 420, as analyzed and compared by the comparison tool 510 in step 545. Of course, in other embodiments, the comparison module 500 may be configured to merely notify the verification module of the discrepancy data 516, whereby the verification module may retrieve the same, as desirable. In still other embodiments, the comparison module 500 may be configured in step 580 to alternatively and/or additionally transmit the discrepancy data 516 to the data module 400, for purposes of, for example, storing and recording the same.

Verification Module 600

With reference to FIG. 8, according to various embodiments, the verification module 600 is configured in step 620 to receive notification of the existence of discrepancy data 516 (see FIG. 5) from the comparison module 500. In certain embodiments, as illustrated in FIG. 8, the verification module 600 then proceeds to step 630, wherein it is configured to retrieve the discrepancy data 516 from the comparison module 500. In at least one embodiment, as previously described, the discrepancy data 516 may, alternatively, be retrieved from the data module 400. In any event, in these and still other embodiments, upon receipt and/or retrieval of the discrepancy data 516, the verification module 600 is configured in step 640 to execute a verification tool 610 (see also FIG. 5).

According to various embodiments, the verification module 600 is particularly configured in steps 640 to execute the verification tool 610 so as to determine whether one or more of the identified discrepancies (as previously described) further constitute a service exception, as illustrated in step 645. It should be understood that in certain embodiments the verification tool 610, like the comparison tool 510, may incorporate any of a variety of algorithms to achieve the data comparison for which it is configured, all as commonly known and understood in the art. However, in these and still other embodiments, the verification tool 610 is configured to compare the discrepancy data 516 against one or more predetermined threshold discrepancy values (versus a comparison of actual versus forecast data, as previous described herein), that values of which are configured to identify particular discrepancies as creating service exceptions. Such predetermined threshold values may, of course, be any of a variety of values, depending upon particular applications; however, it should be understood that exceeding one or more threshold values results in the generation in step 670 of exception data 616 (see FIG. 5), thereby indicating the existence of one or more service exceptions.

For purposes of describing step 645, it is helpful to again return to the previous non-limiting example, whereby the comparison tool 510 identified discrepancy data 516 when the observed departure scan occurred at 4:15 PM, while the forecast departure scan was predicted for 4:00 PM. Receiving such data, the verification tool 640 is configured according to various embodiments to ascertain whether a discrepancy of 15 minutes exceeds a predetermined threshold sufficient to create a service exception. For example, in particular scenarios, a 15 minute delay may not create one or more subsequent impacts to package transit activities, thereby such may be pre-established (by user, shipping carrier, etc.) as not creating a service exception.

Under such non-limiting exemplary circumstances, the verification module 600 is configured to proceed from step 645 into step 650, wherein the discrepancy data 516 (see FIG. 5) received from the comparison module is labeled as discrepancy data 614. From a practical standpoint, such means that the verification tool 610 is configured to confirm that the analyzed data indeed contains discrepancies, but that such do not create one or more service exceptions, as defined by one or more pre-established thresholds, as previously described herein. In such instances, the verification module 600 is further configured to proceed in step 660 to notify the report module accordingly, as in certain embodiments, as will be described in further detail below, one or more reports may be requests and/or generated even in the absence of creation of one or more service exceptions, as may be desirable for particular applications.

Returning to the non-limiting example, wherein the observed departure scan occurred at 4:15 PM, while the forecast departure scan was predicted for 4:00 PM, it may be that in certain embodiments, a 15 minute discrepancy may be such that a service exception is created, whether because subsequent impacts arise and/or because a user wishes to further identify certain non-impact creating discrepancies as service exceptions, however may be desirable for particular applications. In such a scenario, as may be understood with reference again to FIG. 8, the verification module 600 is configured to proceed from step 645 to step 670, wherein exception data is generated and/or identified (see also exception data 616 in FIG. 5). Once generated and identified, the verification module 600 is further configured according to, in step 680 notify the report module 700 of the existence thereof, for further handling.

It should be understood with continued reference to FIG. 8 that in either of steps 660 or 680, the verification module 600 may be configured, much like the comparison module 500 to automatically transmit at least some portion of the discrepancy data 614 and/or the exception data 616, as may be the case. Of course, in other embodiments, the verification module 600 may be configured to merely notify the report module of various data, whereby the report module may retrieve the same, as desirable. In still other embodiments, the verification module 600 may be configured in to alternatively and/or additionally transmit various data to the data module 400, for purposes of, for example, storing and recording the same.

With continued reference to FIG. 8, during step 645, if any service exceptions are identified, as previously described herein, the verification module 600 may be further configured according to various embodiments to assign responsibility of the exception to a particular party (e.g., individual, facility, group, or the like). For example, returning again to our non-limiting scenario, if the late departure scan at location A results in a service exception, the verification module 600 is, in various embodiments, configured to assign responsibility for causing that exception to location A. In certain embodiments, the verification module 600 may further assign responsibility to one or more personnel (e.g., managers) at location A. In other embodiments, the verification module 600 may further and/or alternatively assign responsibility not only for the creation of the service exception, but also for mitigating the same and/or bearing the any cost incurred thereby, and/or forfeiting any incentive rewards otherwise obtainable in the absence of such exceptions.

In this manner, the system of various embodiments of the present invention not only facilitates improved efficiency and effectiveness in identifying service exceptions, but also streamlines and substantially automates mitigation thereof and dispensing of incentives/cost impacts associated therewith. Under prior configurations, such capability was not readily available, resulting in excessive, oftentimes duplicative reports, and little if any direct tie between service exceptions and incentives for mitigating and reducing future occurrences thereof.

Report Module 700

According to various embodiments, with reference to FIG. 9, the report module 700 is configured in steps 720 and 760 to receive notification of clean, discrepancy, and/or exception data, any of which as may be generated by the comparison and/or verification modules 500 and 600, as previously described herein. The report module 700 is in certain embodiments configured, upon receipt of discrepancy or clean data to proceed to step 725, wherein the report module 700 determines whether any reports have been requested under such circumstances. If not, the report module proceeds to step 730, thereby returning to a standby mode, awaiting further notifications of discrepancy, clean, and/or exception data.

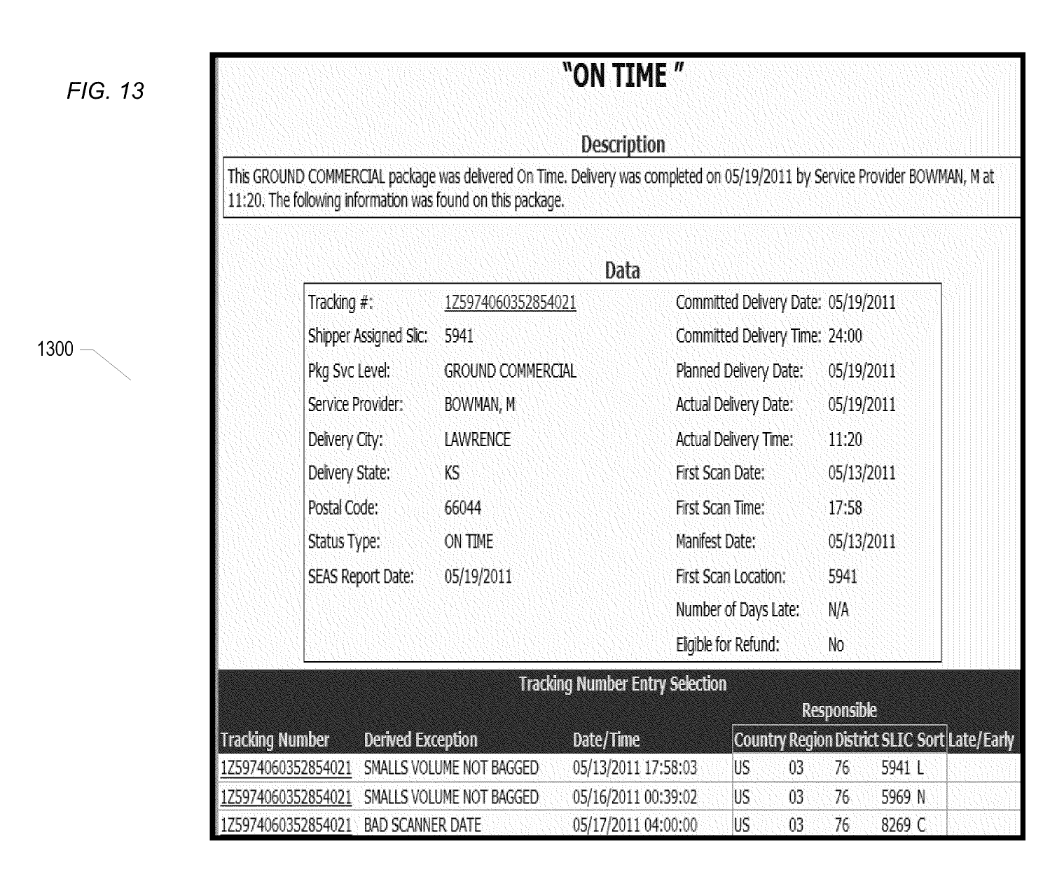

Returning to step 725, if the report module 700 determines that one or more reports are requested, the report module 700 is configured according to various embodiments to proceed to steps 740 and 745, wherein a report tool 710 (see FIG. 5) is executed and the requested report(s) are generated. FIG. 13 illustrates a non-limiting example of a report that the report module 700, and in particular the report tool 710 may be configured to generate during step 745. Specifically, FIG. 13 illustrates an exemplary detailed discrepancy report 1300 of the SEAS 20 according to various embodiments, wherein at least three discrepancies have been identified (e.g., small package (smalls) volume not bagged and bad scanner rate). However, in at least the illustrated scenario of FIG. 13, the package transit data has been denoted as “ON TIME” and thus not creating a service exception.

Returning to FIG. 9, the report module 700, upon completing step 745, may be configured according to various embodiments to proceed to step 750, wherein the one or more generated reports are distributed to one or more recipients. In certain embodiments, the recipients may be one or more individuals or entities having previously requested one or more reports upon the occurrence of non-service exception creating discrepancies. In other embodiments, the recipients may be one or more individuals identified by, for example, the verification module 600 (and associated tool 610—see FIG. 5) as being assigned responsibility for the creation and/or mitigation thereof.

As may be also understood from FIG. 9, according to various embodiments, the report module 700 may receive notification of exception data in step 760, wherein the report module may be configured to, in step 770 retrieve the exception data 616 (see FIG. 5) from the verification module 600. As previously described herein, the report module 700 may in other embodiments be configured to retrieve the exception data from the data module 400 or otherwise, while in still other embodiments, the report module may be configured to passively await receipt of the same, as transmitted by, for example, the verification module 600.

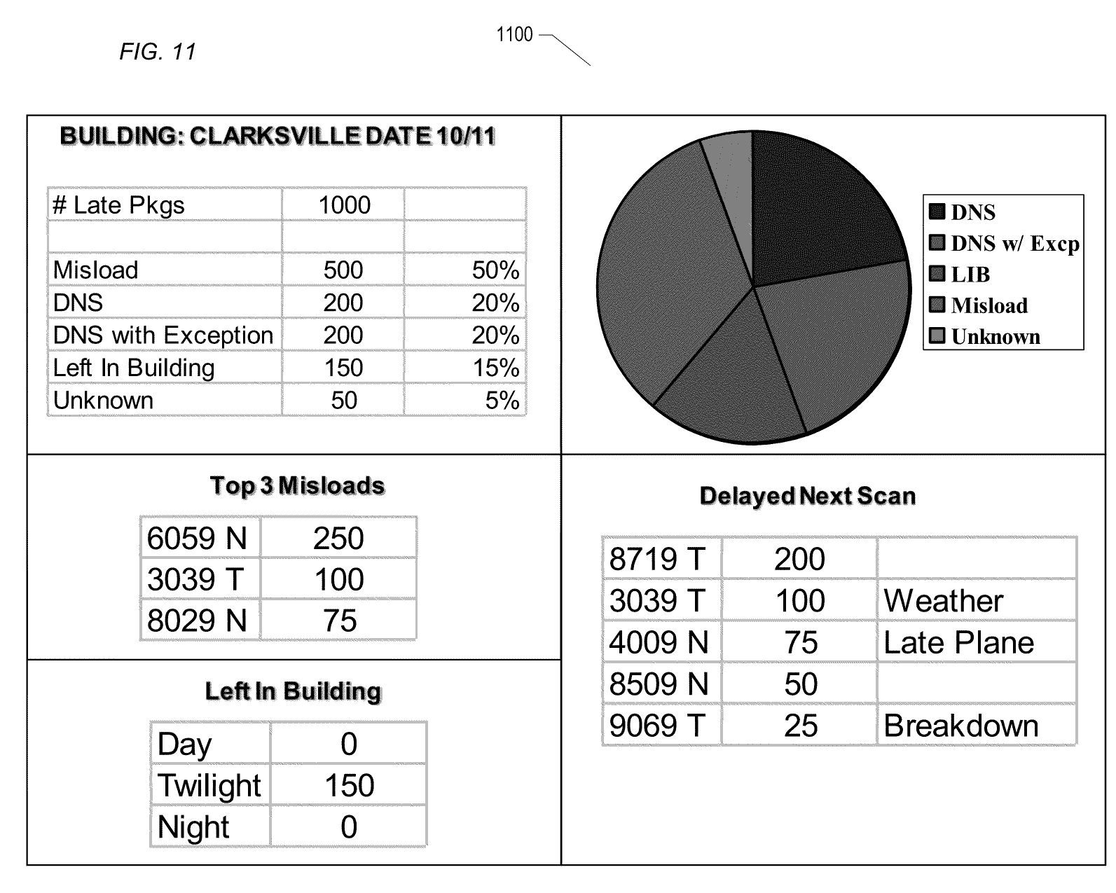

Once exception data is received and/or retrieved in step 770, the report module 700 is configured to, in steps 780 and 785 to execute a report tool 710 (see FIG. 5) and generate one or more exception reports 715 (see also FIG. 5). FIGS. 10-12 illustrate non-limiting examples of exception reports 715, as may be generated. FIG. 10 illustrates a summary exception report 1000, directed toward an assigned individual (as previously described herein). As may be seen, the report may comprise a plurality of data, both in graphical and textual form, with certain embodiments comprising at least an Action Plan for purposes of mitigating the exception to minimize the likelihood of future occurrences. Still other embodiments, as reflected likewise in FIG. 10, may include Work Area Rankings (or the like), intended to reflect performance related criteria of the particularly assigned individual, as compared to others, which may, in turn be used for purposes of performance reviews, or otherwise. FIG. 11, while similar to FIG. 10, illustrates a summary exception report 1100, but reflecting assigned responsibility for an exception to a particular building, as opposed to a particular individual, as in FIG. 10.

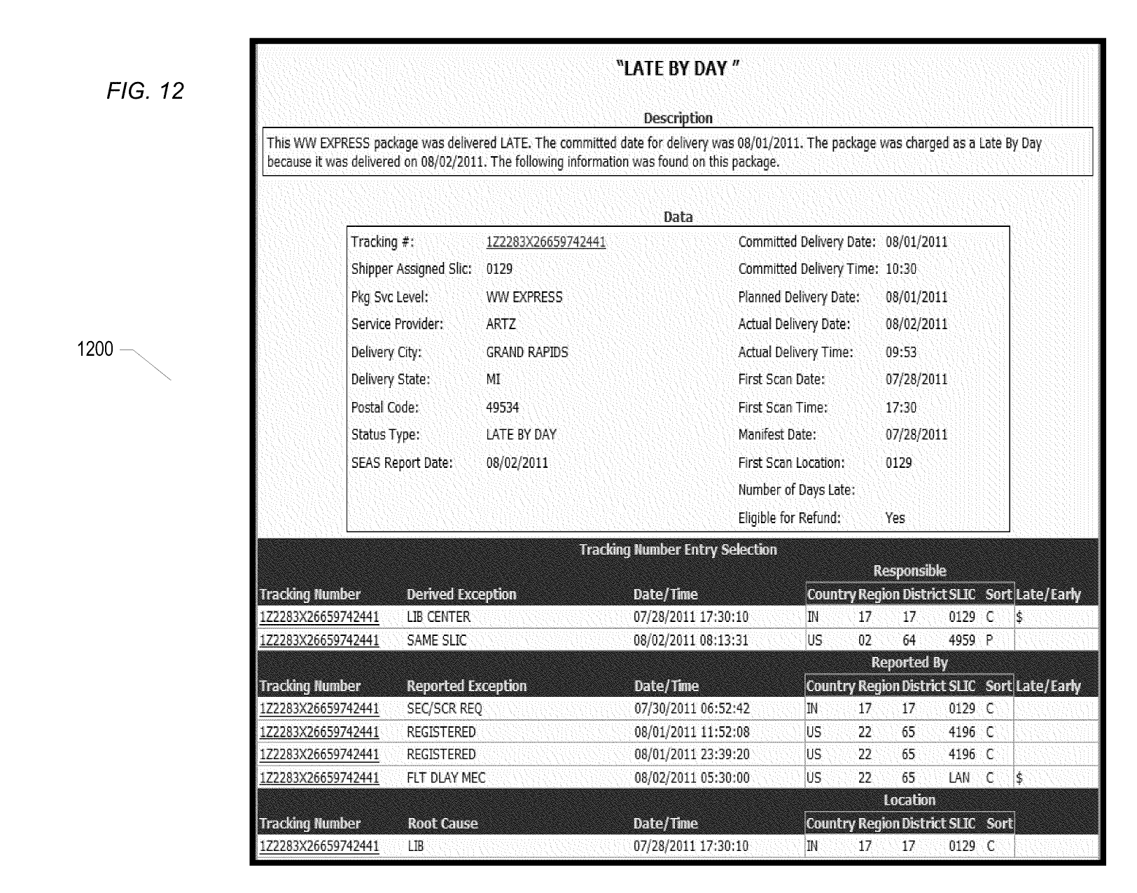

FIG. 12, unlike FIGS. 10 and 11, provides another non-limiting example of an exception report 715 (see FIG. 5), but that it provides a detailed report 1200 for a particular package, as opposed to those broader (e.g., summary) focused reports of FIGS. 10 and 11. With reference to FIG. 12, it may be seen that where one or more exceptions are identified (e.g., derived) and reported, the generated report 1200 may not only assign responsibility therefore (e.g., by identifying the root cause thereof), but also identify impacts created thereby, as reflected by the “LATE BY DAY” header of the particularly illustrated exception report. Of course, still other possible formats of these and still other exemplary exception reports may be envisioned, as within the scope and content of the various embodiments of the present invention; indeed, those illustrated in FIGS. 10-12 are provided for purposes of exemplary disclosure and as such should not be considered limiting.

Returning to FIG. 9 momentarily, it should be further understood that the various steps illustrated therein and executed by the report module 700 may be performed substantially automatically according to certain embodiments, such that focused and pertinently assigned service exception reports are generated by the SEAS system 20, essentially seamlessly, during the transport of the plurality of packages. In these and still other embodiments, it should likewise be understood that the various steps performed by the comparison and verification modules 500 and 600 may similarly substantially automatically performed without extensive (if any) user interaction during the execution thereof. In this manner, the SEAS system 20 may be configured according to various embodiments to provide an improved consolidated and substantially automated reporting system for service exceptions incurred during the course of transportation.

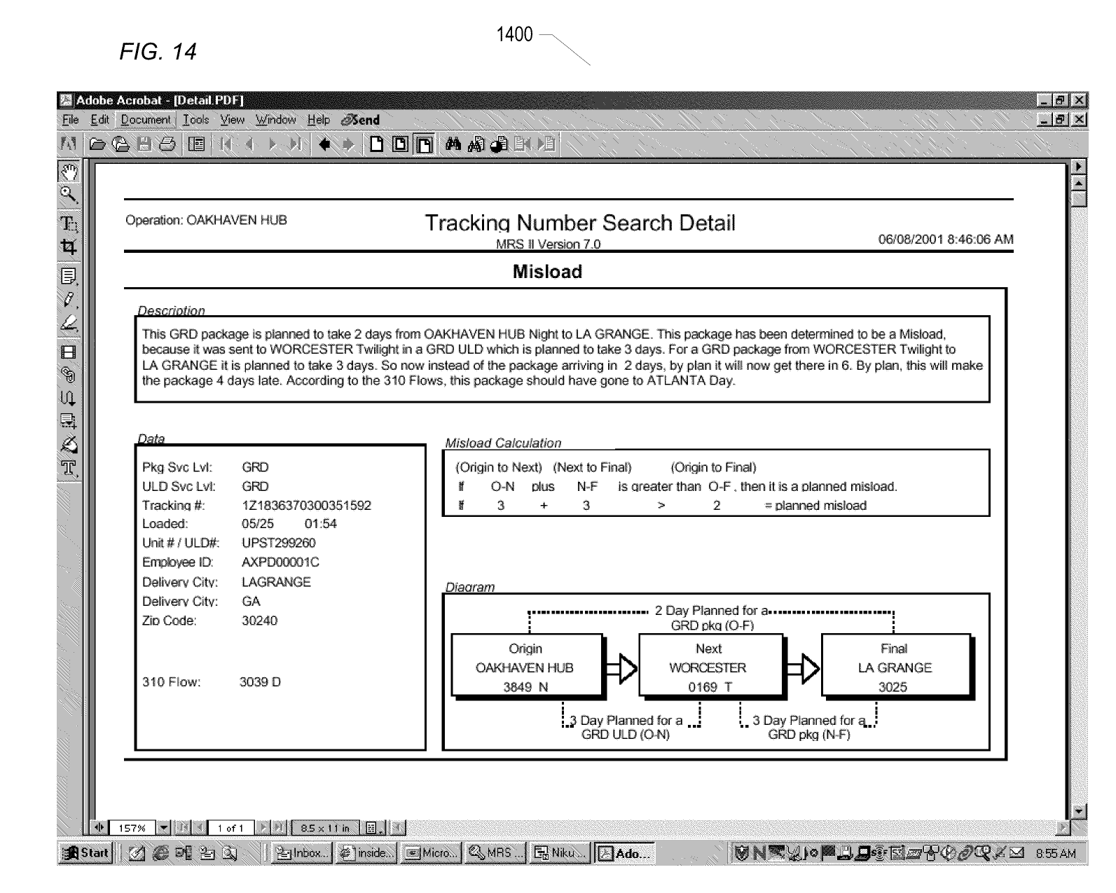

Still further, with reference now to FIGS. 14-16, it should be understood that according to various embodiments, the report module 700 may be further configured to generate one or more ad-hoc reports upon request by any of a variety of users of the system 20. In particular, FIG. 14 illustrates an exemplary tracking number search detailed report 1400 of the SEAS 20 according to various embodiments, wherein, upon request, a user of the system may see a variety of data related to a particular tracking number, as assigned to a particular package within the plurality of packages monitored and handled by the system. For example, the report 1400 may comprise discrepancy calculations (e.g., misload calculations), along with a diagram illustrating forecast data relative to actual data, as contributing to the discrepancy. Of course, it should be understood that any of a variety of such tracking number specific reports may be generated, comprising these and still other contents of data, as may be desirable for particular applications.

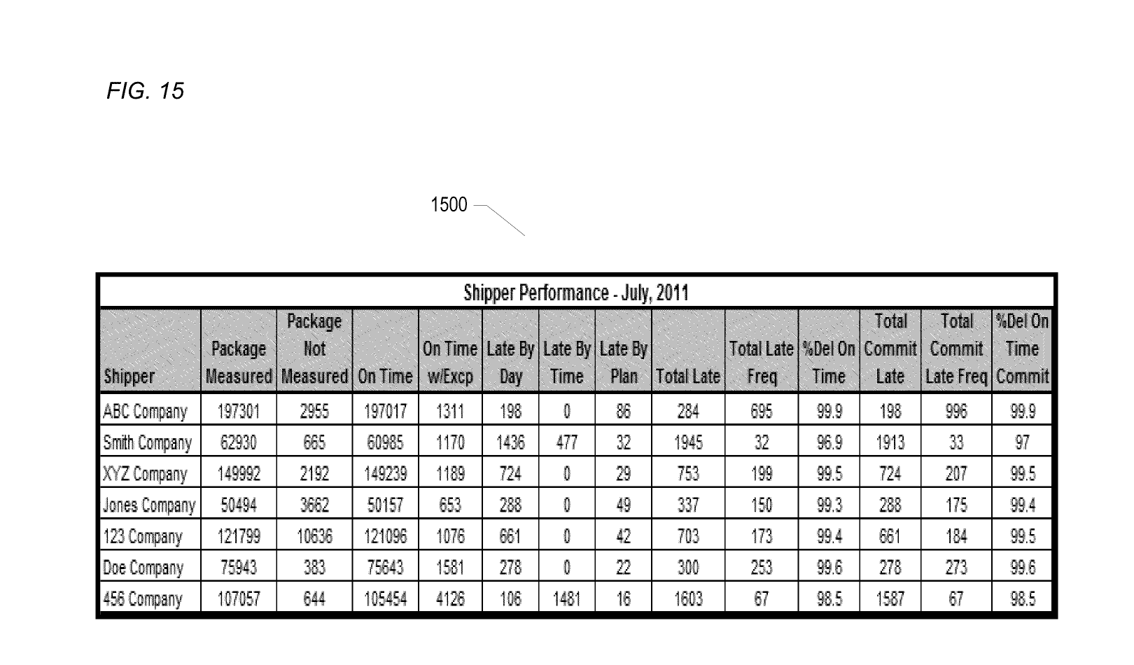

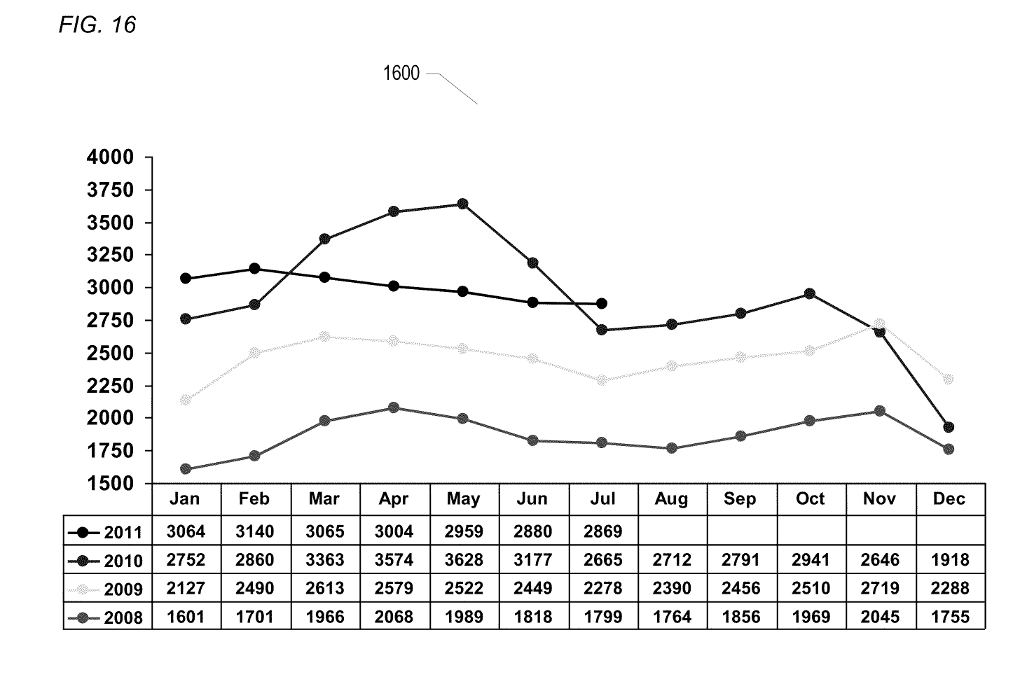

FIG. 15 illustrates another exemplary ad-hoc report, namely a shipper performance report 1500 of the SEAS system 20 according to various embodiments. As best understood from this figure, the system may be configured to compare a carrier shipper's performance for a variety of shippers, so as to ensure that, for example, handling of packages for all customers is comparably efficient. Any of a variety of performance-based or related reports 1500 may be envisioned, as within the scope of the present invention. Similarly, FIG. 16 illustrates an exemplary historical trend chart 1600 of the SEAS system 20 according to various embodiments, which may provide further historical trend data for a particular shipper, or alternatively compare historical data for a plurality of shippers, parameters, exceptions, or the like, however as may be desirable for particular applications. In essence, it should be understood that the report module 700 may be configured to generate any of a variety of reports, whether upon request by a user of the system 20, automatically upon the basis of identifying one or more service exceptions, or otherwise.

### CONCLUSION

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A service exception analysis system comprising:
one or more memory storage areas containing forecast data related to one or more expected parameters associated with transport of a plurality of packages; and
one or more computer processors configured to:
(A) receive actual data related to one or more observed parameters associated with transport of at least one of the plurality of packages;
(B) retrieve at least a portion of the forecast data contained in the one or more memory storage areas;
(C) compare the actual data and the portion of the forecast data to identify one or more discrepancies;
(D) analyze the one or more discrepancies to verify whether one or more service exceptions exist; and
(E) in response to one or more service exceptions being identified, generate one or more service exception reports.

2. The service exception analysis system of claim 1, wherein the one or more computer processors are further configured to transmit the one or more service exception reports to at least one user of the system.

3. The service exception analysis system of claim 1, wherein the one or more computer processors are further configured to, in response to verifying the existence of one or more service exceptions, assign responsibility for the service exception to at least one user of the system.

4. The service exception analysis system of claim 3, wherein the one or more computer processors are further configured to, in response to assigning responsibility for the service exception, transmit the one or more service exception reports to the at least one assigned user.

5. The service exception analysis system of claim 3, wherein the user is a particular personnel manager assigned responsibility for mitigating the creation of service exceptions by managed personnel.

6. The service exception analysis system of claim 3, wherein the user is a facility manager assigned responsibility for minimizing the occurrence of service exceptions at the facility.

7. The service exception analysis system of claim 1, wherein the one or more observed parameters are selected from the group consisting of: early departure, early arrival, late departure, late arrival, early delivery, late delivery, misflow, misload, missed scan, small package error, load volume error, and errant upload.

8. The service exception analysis system of claim 1, wherein the one or more expected parameters are selected from the group consisting of: predicted departure, predicted arrival, predicted delivery, predicted flow, predicted load, predicted scan, predicted small package handling, predicted load volume, and predicted upload.

9. The service exception analysis system of claim 1, wherein the one or more computer processors are configured to:
identify the one or more discrepancies based at least in part upon a first threshold; and
verify the existence of the one or more service exceptions based at least in part upon a second threshold, the second threshold being higher relative to the first threshold.

10. The service exception analysis system of claim 9, wherein the one or more computer processors are further configured to, in response to only the first threshold being exceeded, generate one or more discrepancy reports.

11. The service exception analysis system of claim 1, wherein the one or more computer processors are further configured to automatically identify the one or more discrepancies and to automatically verify the existence of one or more service exceptions.

12. The service exception analysis system of claim 11, wherein the one or more computer processors are further configured to:
automatically generate the one or more service exception reports;
automatically assign responsibility for the service exception to at least one user of the system; and
automatically transmit the one or more service exception reports to the at least one assigned user.

13. A computer program product comprising at least one computer-readable storage medium having computer-readable program code portions embodied therein, the computer-readable program code portions comprising:
a first executable portion configured for receiving data associated with transport of a plurality of packages, wherein the data comprises:
forecast data related to one or more expected parameters associated with transport of a plurality of packages; and
actual data related to one or more observed parameters associated with transport of at least one of the plurality of packages;
a second executable portion configured for comparing the actual data relative to the forecast data to identify one or more discrepancies; and
a third executable portion configured for analyzing the one or more discrepancies to verify whether one or more service exceptions exist.

14. The computer program product of claim 13, wherein the third executable portion is further configured for assigning responsibility for the service exception to at least one user of the system.

15. The service exception analysis system of claim 14, wherein the user is a particular personnel manager assigned responsibility for mitigating the creation of service exceptions by managed personnel.

16. The service exception analysis system of claim 14, wherein the user is a facility manager assigned responsibility for minimizing the occurrence of service exceptions at the facility.

17. The computer program product of claim 14, wherein the computer program product is adapted for, in response to one or more service exceptions being identified, generating one or more service exception reports.

18. The computer program product of claim 17, wherein the computer program product is adapted for, in response to one or more service exceptions being identified, transmitting the one or more service exception reports to only the at least one assigned user.

19. The computer program product of claim 18, wherein the computer program product is adapted for:
automatically identifying the one or more discrepancies;
automatically verifying the existence of one or more service exceptions;
automatically generating the one or more service exception reports;
automatically assigning responsibility for the service exception to the at least one user; and
automatically transmitting the one or more service exception reports to the at least one assigned user.

20. A computer-implemented method for managing service exceptions related to transport of a plurality of packages, the method comprising the steps of:
(A) receiving and storing actual data within one or more memory storage areas, the actual data being related to one or more observed parameters associated with the transport of at least one of the plurality of packages;
(B) retrieving from the one or more memory storage areas at least a portion of forecast data, the forecast data being related to one or more expected parameters associated with the transport of the at least one of the plurality of packages;
(C) comparing, via at least one computer processor, the actual data and the portion of the forecast data to identify one or more discrepancies;
(D) analyzing, via the at least one computer processor, the one or more discrepancies to verify whether one or more service exceptions exist; and
(E) in response to one or more service exceptions being identified, generating one or more service exception reports.
